(19) United States
(12) Patent Application Publication
(10) Pub. No.: US 2010/0233441 A1
(43) Pub. Date: Sep. 16, 2010

(54) THREE-DIMENSIONALLY PATTERNED NATURAL LEATHER

(75) Inventors: Harukazu Kubota, Fukui (JP); Kenta Kuruba, Fukui (JP); Yoshikatsu Itoh, Fukui (JP)

Correspondence Address: GREER, BURNS & CRAIN, 300 S WACKER DR, 25TH FLOOR, CHICAGO, IL, 60606, US

(73) Assignee: SEIREN CO., LTD., Fukui (JP)

(21) Appl. No.: 12/161,661

(22) PCT Filed: Sep. 25, 2007
(86) PCT No.: PCT/JP2007/069156

§ 371 Date: Jul. 21, 2008

(30) Foreign Application Priority Data
Sep. 29, 2006 (JP) 2006-266804

(51) Int. Cl. C14C 11/00; B05D 7/12; B32B 9/04; B41M 5/00

(52) U.S. Cl. 428/195.1; 427/510; 427/511

(57) ABSTRACT

A natural leather having a three-dimensional pattern formed on the surface thereof is provided. The three-dimensionally patterned natural leather permits a minute three-dimensional expression such as small dots and thin lines, is high in the degree of freedom of the three-dimensional pattern, can retain the three-dimensional pattern even with the lapse of time and retain the characteristics peculiar to the natural leather. The three-dimensional pattern is formed by a resin portion which covers by coating the surface of an undercoating layer of the natural leather partially in a pattern shape. The resin portion has a maximum thickness of 20 to 400 μm.

### FIELD OF THE INVENTION

The present invention relates to a natural leather and more particularly to a natural leather having a three-dimensional pattern formed on its surface and suitable for use as clothing, bags, shoes, interior materials and vehicular interior materials.

### BACKGROUND OF THE INVENTION

Heretofore, as a method for forming a three-dimensional pattern on the surface of a natural leather there has been known a method wherein the natural leather is set within a metallic, wooden or resin die having a desired pattern formed by relief engraving or reverse engraving, followed by heating and pressing to emboss the leather surface, as is disclosed for example in JP 64-51499A and JP 7-138600A. Further, in JP 2002-188100A is disclosed a method wherein an image is printed to the surface of leather by, for example, transfer printing, silk screen printing, or ink jet printing, on the basis of digital image data and at the same time the leather is subjected to three-dimensional molding with use of a three-dimensional die fabricated also on the basis of digital image data, to afford a highly decorative natural leather having both printed portion and three-dimensional portion integral with each other.

In these conventional methods, however, since concave portions are formed by forcing the natural leather into the die and compressing it partially, the natural leather thus formed with a three-dimensional pattern gradually becomes unable to retain its concave shape under the action of its restoring force which tends to return to the original thickness, thus giving rise to the problem that the three-dimensional pattern disappears with the lapse of time. Besides, a minute three-dimensional expression such as the expression of small dots and thin lines is difficult and the degree of freedom of three-dimensional patterns capable of being formed is low.

Further, in JP 2004-217744A is disclosed a method wherein a natural leather is treated with a mercapto compound solution to cleave collagen protein contained in the leather and embossing is performed in this state, then the collagen protein is recombined, thereby fixing a three-dimensional shape of the leather. However, since the crystallization degree of the leather changes, there has been the problem that the characteristics peculiar to the natural leather such as texture and sense of touch are impaired. There also still remain the problem that the freedom of a three-dimensional pattern is low.

On the other hand, there is known a method wherein resin is applied to the surface of fabric to form a three-dimensional pattern. For example, in JP 2004-306469A is disclosed a method involving applying transparent ink containing an ultraviolet curable resin and not containing a colorant to fabric by an ink jet method and curing the ink with ultraviolet light, then repeating this process to form a three-dimensional pattern on the surface of the fabric, thereafter applying color ink containing both an ultraviolet curable resin and a colorant to the fabric surface and curing the ink with ultraviolet light to form a three-dimensional image of excellent design on the fabric surface. In this case, the transparent ink layer is formed throughout the whole surface of the fabric in order to prevent irregular reflection of light and prevent blotting of the color ink. In case of applying such a method to a natural leather, there has been the problem that the characteristics peculiar to the natural leather such as texture, sense of touch, wrinkles and grain feeling are impaired. Moreover, as to the natural leather, it is most popular to process it while making the most of its unique characteristics, and there has been no such idea as imparting a foreign matter to the surface of the natural leather to form a three-dimensional pattern.

### DISCLOSURE OF THE INVENTION

### Object of the Invention

The present invention has been accomplished in view of the above-mentioned circumstances and it is an object of the invention to provide a natural leather having a three-dimensional pattern formed on the surface of the leather, permitting a minute three-dimensional expression such as the expression of small dots and thin lines, high in the degree of freedom of the three-dimensional pattern, capable of retaining the three-dimensional pattern even with the lapse of time and retaining the characteristics peculiar to the natural leather.

### SUMMARY OF THE INVENTION

In a first aspect of the present invention there is provided a three-dimensionally patterned natural leather having an undercoating layer and a three-dimensional pattern formed on the surface of the undercoating layer, the three-dimensional pattern being formed by a resin portion which covers by coating the surface of the undercoating layer partially in a pattern shape, the resin portion having a maximum thickness of 20 to 400 μm.

Preferably, the ratio of coating of the resin portion for the surface of the undercoating layer is in the range of 3 to 60%.

Preferably, the resin portion has a Martens hardness of 1 to 10 N/mm².

Preferably, the resin portion is formed by a cured product of an ultraviolet curable resin.

In a second aspect of the present invention there is provided a method for fabricating a three-dimensionally patterned natural leather, comprising the steps of applying a coating material for forming an undercoating layer to the surface of a natural leather and applying a heat treatment to the coating material to form an undercoating layer, and applying a coating material for forming a resin portion to the surface of the undercoating layer partially in a pattern shape and applying a heat treatment or ultraviolet light irradiation to the coating material to form a three-dimensional pattern comprising a resin portion, the resin portion having a maximum thickness of 20 to 400 μm.

Preferably, the value obtained by subtracting a static surface tension at 25° C. of the resin portion-forming coating material from surface free energy at 25° C. of the undercoating layer is in the range of −5 to 15 dyne/cm.

Preferably, the application of the resin portion-forming coating material is performed by ink jet printing.

### EFFECTS OF THE INVENTION

According to the present invention it is possible to provide a natural leather permitting a minute three-dimensional expression such as the expression of small dots and thin lines and having a three-dimensional pattern high in the degree of freedom. Besides, the three-dimensional pattern does not disappear even with the lapse of time and the characteristics peculiar to the natural leather are not impaired.

### BRIEF DESCRIPTION OF THE DRAWINGS

FIG. 1 illustrates a three-dimensionally patterned natural leather according to the present invention, in which FIG. 1-1 is a plan view and FIG. 1-2 is a sectional view taken along line A-A in FIG. 1-1;

FIG. 2 illustrates the thickness of a resin portion;

FIG. 3 shows an example (grain pattern) of the three-dimensional pattern (black indicates a resin portion);

FIG. 4 shows another example (alligator pattern) of the three-dimensional pattern (black indicates a resin portion); and

FIG. 5 shows a further example (geometrical pattern) of the three-dimensional pattern (black indicates a resin portion).

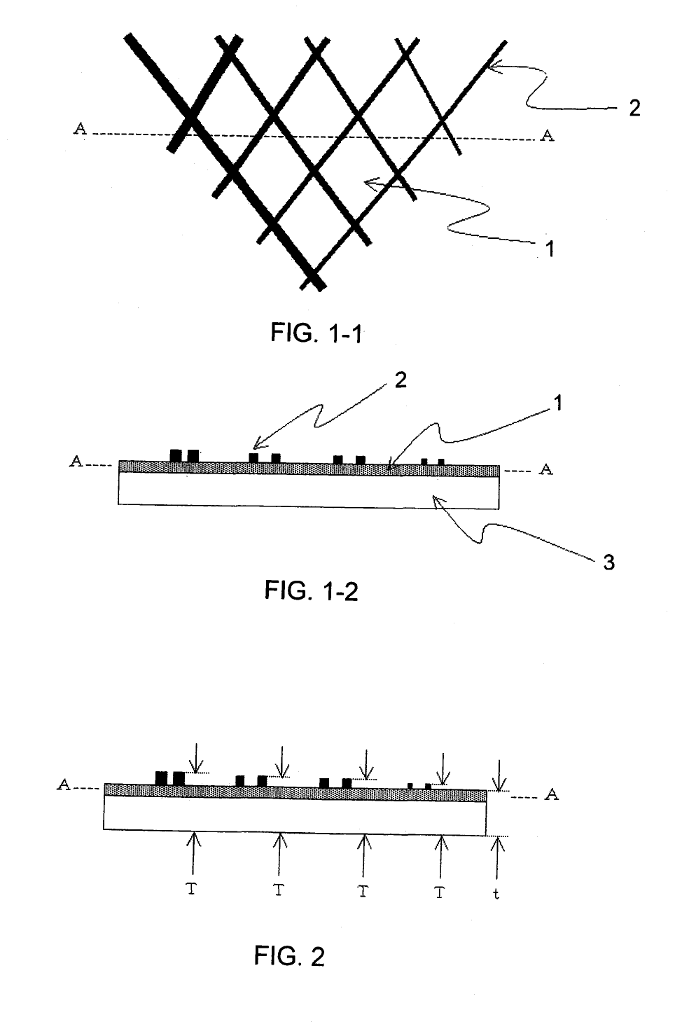

In FIG. 1, the reference numeral 1 denotes an undercoating layer, the numeral 2 denotes a resin portion (three-dimensional pattern), and numeral 3 denotes a natural leather. In FIG. 2, the reference mark T denotes a leather thickness including the resin portion and t denotes a leather thickness not including the resin portion.

Maximum thickness of the resin portion=Tₘₐₓ−t

### EMBODIMENTS OF THE INVENTION

The present invention will be described in detail hereinafter.

In the three-dimensionally patterned natural leather according to the present invention, an undercoating layer is formed on the natural leather, a three-dimensional pattern is formed by a partial patternwise resin coating on the surface of the undercoating layer of the natural leather, the resin portion having a maximum thickness of 20 to 400 μm.

As examples of the natural leather used in the present invention, mention may be made of conventional known natural leathers such as leathers of mammals, e.g., cow, horse, pig, goat, sheep, deer, and kangaroo, leathers of birds, e.g., ostrich, and leathers of reptiles, e.g., turtle, big lizard, python, and alligator. Above all, cow leather is preferred on the ground that the grain has few concaves and convexes and it is easy to form a three-dimensional pattern.

Raw hides of those natural leathers usually go through the processes of tanning, re-tanning, neutralizing, dyeing, oiling, and drying, and thereby become leathers which are in a state of semi-finished products called crusts. An undercoating layer is formed on a grain layer surface of each crust.

The undercoating layer is formed on the whole surface of the natural leather in order to smooth the surface of the natural leather, eliminate factors unstable for the formation of a three-dimensional pattern with resin such as a difference between individual leathers or portions of each leather, wormy portions and scratches, and thereby make the surface uniform. The thickness of the undercoating layer is not specially limited insofar as the leather surface can be made uniform, but is preferably in the range of 10 to 40 μm, more preferably 15 to 30 μm. If the thickness is less than 10 μm, there is a fear that it may be impossible to make the leather surface uniform to a satisfactory extent, and if the thickness exceeds 40 μm, there is a fear that the texture and sense of touch of the entire leather may become hard, and thereby the characteristics of peculiar to the natural leather may be impaired.

The resin used for forming the undercoating layer is not specially limited, but a suitable one may be selected from among those generally used for leather. Usually a thermoplastic resin or a thermocrosslinking type resin is used. Examples are polyurethane resin, acrylic resin, polyvinyl chloride resin, polyester resin, polyamide resin, and silicone resin. These resins may be used each alone or in combination of two or more. Above all, polyurethane resin and acrylic resin are preferred in point of both being superior in film strength. The type of the coating material containing any of the above resins may be an emulsion or a solution in a solvent, but the emulsion is preferred because it penetrates little into the natural leather and can afford leather of a good texture. Also in point of reduced environmental load the emulsion is advantageous.

Where required, the coating material may contain arbitrary components such as colorant, delustering agent, smoothing agent, crosslinking agent, defoaming agent, foam stabilizer, dispersant, anti-tack agent, wettability improving agent, and thickener.

The undercoating layer as referred to herein is a generic term for the coating layer formed on the surface of the natural leather prior to forming a three-dimensional pattern by the resin portion. It is constituted by at least one coating layer. It may comprise two or more coating layers of the same or different coating materials. The undercoating layer can be formed by applying the undercoating layer-forming coating material containing any of the above resins to the natural leather surface and heat-treating the coating material.

The method for application of the coating material is not specially limited. For example, there may be adopted a conventional known method such as a reverse roll, spray, roll, gravure, kiss roll or knife coating method. Above all, spray coating is preferred because it can form a uniform thin layer.

Heat treatment is performed for evaporating the solvent contained in the undercoating layer-forming coating material and for drying the resin. Further, in case of using a crosslinking agent which induces a crosslinking reaction upon heat treatment, the heat treatment is performed for accelerating reaction to form a film having sufficient strength. For preventing excess evaporation of moisture from the natural leather it is preferable to perform heat treatment in such a manner that the temperature of the natural leather itself does not exceed 80° C. Therefore, the heat treatment temperature is preferably in the range of 60 to 120° C., more preferably 70 to 100° C. If the heat treatment temperature is lower than 60° C., there is a fear that a long time may be needed for the heat treatment, and thereby the process load may be high, or the crosslinking of resin may be insufficient, and thereby abrasion resistance may be unobtainable. If the heat treatment temperature exceeds 120° C., there is a fear that the texture and sense of touch of the natural leather may become hard.

The heat treatment time is preferably in the range of 2 to 30 minutes, more preferably 5 to 10 minutes. If the heat treatment time is shorter than 2 minutes, there is a fear that abrasion resistance may be unobtainable due to insufficient crosslinking of resin. If the heat treatment time exceeds 30 minutes, there is a fear that moisture may be lost to excess from the natural leather, and thereby the natural leather may be shrunk to form undesirable wrinkling, and also thereby the texture and sense of touch may become hard.

Surface free energy at normal temperature of the undercoating layer thus formed is preferably in the range of 18 to 60 dyne/cm, more preferably 20 to 50 dyne/cm. By the surface free energy as referred to herein is meant a value indicating what surface tension of liquid a solid surface gets wet, which value can be obtained in accordance with a method based on ASTM D5946 (Standard Test Method for Corona-Treated Polymer Films using Water Contact Angle Measurements). That is, if a contact angle of water (pure water) relative to the undercoating layer in place of the corona-treated resin film, the surface free energy corresponding to this contact angle can be derived by using the surface energy conversion chart described in ASTM D5946. In the present invention, in 10 seconds after dropping 1 μl of water onto the surface of the undercoating layer formed on the natural leather surface under the condition of 25° C., a contact angle was measured as the contact angle of water with use of a portable contact angle meter PG-X (a product of FIBRO system ab).

If the surface free energy at normal temperature of the undercoating layer is less than 18 dyne/cm, the wettability of the undercoating layer for the resin portion-forming coating material decreases, so that the coating material becomes easier to be repelled by the undercoating layer and thus there is a fear the adhesion to the resin portion may be deteriorated and abrasion resistance may become unobtainable.

If the surface free energy exceeds 60 dyne/cm, the wettability for the resin portion-forming coating material increases, so that the coating material becomes easier to penetrate into the undercoating layer and thus there is a fear that a desired thickness of the resin portion may be unobtainable or a minute three-dimensional expression may become difficult.

Where required, a hydrophilizing treatment such as flame, plasma or corona treatment may be applied to the undercoating layer.

In the three-dimensionally patterned natural leather according to the present invention, a three-dimensional pattern comprising a resin portion which covers the surface of the undercoating layer on the natural leather partially by coating is formed on undercoating layer.

As shown in FIG. 1, a difference in height occurs between the undercoating layer surface and the resin portion as a result of the undercoating layer of the natural leather surface being partially coated with resin, whereby there is formed a three-dimensional pattern. Unlike the conventional three-dimensional pattern formed by partially compressing a natural leather by embossing to form concaves, the three-dimensional pattern according to the present invention comprises convexes formed with resin while leaving the leather thickness intact and therefore does not disappear even with the lapse of time. Besides, since the resin portion is partially formed, the characteristics peculiar to the natural leather such as texture, sense of touch, wrinkles and grain feeling are not impaired, either.

The shape of the resin portion is not specially limited, but may be any shape insofar as the shape brings about a suitable pattern, including a conventional embossed pattern. It is possible to effect a minute expression. For example, there may be adopted a geometrical pattern such as any one or a combination of random dots, lines, circles, triangles, quadrangles, and dotted lines, or a character pattern based on a free idea. A suitable pattern shape may be freely selected according to the purpose of use.

As the most minute expression it is possible to express a three-dimensional pattern wherein the width of a thin line is 50 μm or the diameter of a dot is 50 μm or a short side of geometrical pattern is 50 μm. The thickness of a three-dimensional pattern can be changed stepwise and it is possible to form a gentle curved line-like three-dimensional pattern, so that it is possible to impart a further shadowed expression to the natural leather.

It is required that the maximum thickness of the resin portion be in the range of 20 to 400 μm. If the maximum thickness is less than 20 μm, there is a fear that a clear three-dimensional feeling may not be obtained and it may become difficult to make a minute three-dimensional pattern such as a three-dimensional pattern formed by curved lines of stepwise changing heights. If the maximum thickness of the resin portion exceeds 400 μm, there is a fear that the texture and sense of tough of the entire leather may become hard and the characteristics peculiar to the natural leather may be impaired. A more preferred maximum thickness of the resin portion is in the range of 40 to 300 μm.

The maximum thickness of the resin portion indicates a maximum difference in height between the undercoating layer surface and the resin portion. It is determined by measuring the size of the largest portion in the thickness direction of the leather including the resin portion and the size in the thickness direction of the leather (including the undercoating layer) not coated with the resin portion both from an electron photomicrograph of the section in the thickness direction of the leather and by subsequently calculating the difference between both sizes.

A coating ratio of resin portion relative to the undercoating layer surface is preferably in the range of 3 to 60%, more preferably 5 to 40%. If the coating ratio is less than 3%, there is a fear that it may become difficult to express a uniform three-dimensional pattern on the whole leather surface. If the coating ratio exceeds 60%, there is a fear that the texture and sense of touch of the entire leather may become hard or wrinkles and grain feeling may disappear and thereby the characteristics peculiar to the natural leather may be impaired.

The coating ratio of the resin portion relative to the undercoating layer surface was determined in the following manner. The natural leather having a three-dimensional pattern according to the present invention is cut into the size of 5 cm×5 cm, then this cut piece is read into a personal computer with use of a scanner, then the portion coated with resin and the portion not coated with resin are binarized and the coating ratio is calculated using the following equation 1:

Coating ratio (%)=area of the resin-coated portion/total area of natural leather×100 [1]

Alternatively, it may be calculated from image data of the coating pattern.

Martens hardness of the resin portion is preferably in the range of 1 to 10 N/mm², more preferably 5 to 8 N/mm². By Martens hardness is meant a physical property value defined by IS014577 and determined by pushing an indenter into the to-be-measured object under the application of a load. Martens hardness has recently been attracting attention of many concerns because a highly accurate measured value is obtained for a very soft film or thin film. The measurement of Martens hardness can be done using a commercially available device such as, for example, an ultramicrohardness meter, Fisher Scope PICODENTOR HM500 (a product of Fisher Instruments K.K.).

More specifically, an indenter is pushed into the surface of a to-be-measured object under the application of a test load F[N], then an indenter-intruded surface area As (h)[mm²] is determined from the indentation quantity h[mm] and the indenter shape, and Martens hardness HM [N/mm²] is determined from the following equation 2:

HM=F/As(h) [2]

For measuring Martens hardness in the present invention there was adopted a method involving using the above PICODENTOR HM500, pushing a Vickers indenter into the surface of the to-be-measured object so as to give a maximum load of 0.050 mN over a period of 10 seconds, holding the test load for 5 seconds and subsequently decreasing the load likewise. The following equation 3 is for calculating the surface area in case of using the Vickers indenter:

$$\begin{matrix}As ( h ) = k \times {h}^{2} \\ = 26.43 \times {h}^{2}\end{matrix} \qquad [ 3 ]$$

k: coefficient peculiar to the indenter
h: indentation quantity of the indenter

As the to-be-measured object there was used a separately-prepared cured film of the same composition as the resin portion. More specifically, with use of a bar coater, a resin portion-forming coating material was applied to a thickness of 10 μm onto a smooth polyester film having a thickness of 100 μm as determined by the dial gauge method and not having been subjected to any such surface treatment as embossing or corona treatment, followed by curing.

If Martens hardness is less than 1 N/mm², there is a fear of the resin portion being scraped off by wear and consequent disappearance of the three-dimensional portion with the lapse of time. If Martens hardness exceeds 10 N/mm², there is a fear that the texture and sense of touch of the entire leather may become hard, and thereby the characteristics peculiar to the natural leather may be impaired, and the resin portion may not follow up expansion and contraction of the leather, and thereby the resin portion may be cracked.

The resin used for forming the resin portion is not specially limited. Examples of the resin include polyethylene resin, polypropylene resin, polystyrene resin, acrylic resin, polyester resin, polyurethane resin, polycarbonate resin, nylon resin, epoxy resin, fluorine resin, vinyl chloride resin, and ethylene-vinyl acetate resin. Also employable are silicone rubber, ethylene propylene rubber, butadiene rubber, butyl rubber, nitrile rubber, acrylic rubber, and fluorine-containing rubber. These may be used each alone or as a combination of two or more. When importance is attached to the resistance to light and to heat, aliphatic resins and rubbers are preferred. When importance is attached to abrasion resistance, it is preferable for the resin to have a moderate degree of hardness as noted above, preferred examples of which are thermosetting resin, ultraviolet curable resin, and thermoplastic resin of a three-dimensional crosslinked structure prepared by adding a crosslinking agent to the thermoplastic resin. Ultraviolet curable resin is particularly preferred for the reason to be set forth later. The type of the coating material containing any of the above resins may be any of emulsion, solvent solution, and solventless solution. Particularly, a solvent solution or a solventless solution is preferred on the ground that it is possible to increase the content of solids in the coating material and that convexes can be formed effectively in a small amount of the coating material.

Where required, arbitrary components such as colorant, e.g., pigment or dye, dispersant, defoaming agent, crosslinking agent, polymerization initiator, heat stabilizer, antioxidant, light stabilizer, flame retardant, lubricant, and wettability improver, may be added to the coating material.

A static surface tension at normal temperature of the resin portion-forming coating material containing any of the above resins is preferably in the range of 18 to 45 dyne/cm, more preferably 18 to 35 dyne/cm. By the surface tension is meant a tension acting along the surface of liquid when the liquid surface tends to contract with its cohesive force, and by the static surface tension is meant a surface tension when the surface is static. The static surface tension can be measured by the plate method or the ring method. In the present invention it was measured by the plate method using an automatic surface tension meter CBVP-A3 (a product of Kyowa Interface Science Co., Ltd.) under the condition of 25° C.

If the static surface tension at normal temperature of the resin portion-forming coating material is less than 18 dyne/cm, the wettability of the coating material for the undercoating layer increases, so that the coating material becomes easier to penetrate into the undercoating layer and thus there is a fear that a desired thickness of the resin portion may be unobtainable or a minute three-dimensional expression may become difficult to appear. If the static surface tension exceeds 45 dyne/cm, the wettability of the coating material for the undercoating layer decreases, so that the coating material becomes easier to be repelled by the undercoating layer and thus there is a fear that the adhesion to the undercoating layer may be deteriorated and abrasion resistance may be unobtainable.

It is preferable that the value obtained by subtracting the static surface tension at normal temperature of the resin portion-forming coating material from the surface free energy at normal temperature of the undercoating layer be in the range of −5 to 15 dyne/cm, more preferably 0 to 10 dyne/cm. If this value is less than −5 dyne/cm, the wettability of the coating material for the undercoating layer decreases, so that the coating material becomes easier to be repelled by the undercoating layer, and thus there is a fear that the adhesion between the undercoating layer and the resin portion may be deteriorated and abrasion resistance may be unobtainable. If the value in question exceeds 15 dyne/cm, the wettability of the coating material for the undercoating layer increases, so that the coating material becomes easier to penetrate into the undercoating layer, and thus there is a fear that a desired thickness of the resin portion may be unobtainable or a minute three-dimensional expression may become difficult to appear. Particularly, in the case where the viscosity of the resin portion-forming coating material is low, the phenomenon related to wettability and repellency is apt to occur. Accordingly, it is important for the value in question to satisfy the above range.

The value obtained by subtracting the static surface tension at normal temperature of the resin portion-forming coating material from the surface free energy at normal temperature of the undercoating layer can be maintained within the range of −5 to 15 dyne/cm by either a method wherein the surface free energy of the undercoating layer is changed to adjust the value or a method wherein the static surface tension of the coating material is changed to adjust the value. More specifically, in the former method, the value can be adjusted by subjecting the undercoating layer to a hydrophilizing treatment such as flame, plasma or corona treatment. In the latter method, the value can be adjusted by adding a wettability improver to the coating material. Above all, a silicone- or fluorine-based wettability improver is preferred because even a small amount thereof would take effect.

The resin portion can be formed by applying the resin portion-forming coating material described above to an undercoating layer of a natural leather partially in a pattern shape and subsequent heat treatment or ultraviolet light irradiation.

How to apply the coating material is not specially limited. There may be adopted a conventional known method, e.g., spray coating, gravure coating, screen printing, rotary screen printing, and ink jet printing. Above all, ink jet printing is preferred which permits a minute three-dimensional expression by fine adjustment of the amount of ink to be discharged. Also as means for forming a three-dimensional pattern without being influenced by the presence or absence of wrinkles or grain feeling inherent on the surface of a natural leather, non-contact type ink jet printing is preferred.

According to ink jet printing, not only for a small dot or thin line of 50 μm or so but also for a stepwise change of height the amount of ink to be discharged can be finely adjusted according to a desired three-dimensional pattern. In this case, it is important that, before the shape of the applied coating material changes due to a change in viscosity, the coating material be cured while maintaining its shape just after the application. In this connection, an ultraviolet curable resin which cures in an instant upon irradiation to ultraviolet light is particularly preferred. Moreover, since the ultraviolet curable resin can be cured without heating, the characteristics peculiar to the natural leather, such as texture and sense of touch, are not impaired. These advantages are recognized also in other coating methods than the ink jet printing method.

The coating material containing the ultraviolet curable resin generally comprises an oligomer, a monomer, a photopolymerization initiator, and arbitrary components which are added if necessary. Upon irradiation of ultraviolet light, the photopolymerization initiator becomes a radical, which activates polymerizable double bonds of the oligomer and the monomer, creating a chain linkage in a successive manner.

As examples of the oligomer, mention may be made of urethane acrylate, polyester acrylate, epoxy acrylate, silicon acrylate, and polybutadiene acrylate. These may be used each alone or in combination of two or more. Above all, urethane acrylate is preferred on the ground of it being superior in adhesiveness.

As examples of the monomer, mention may be made of monofunctional 2-(2-ethoxyethoxy)ethyl acrylate, stearyl acrylate, tetrahydrofurfuryl acrylate, lauryl acrylate, 2-phenoxyethyl acrylate, isodecyl acrylate, isooctyl acrylate, tridecyl acrylate, caprolactone acrylate, ethoxylated nonylphenol acrylate, isobornyl acrylate, alkoxylated nonylphenyl acrylate, and alkoxylated 2-phenoxyethyl acrylate, bifunctional 1,3-butylene glycol diacrylate, 1,4-butanediol diacrylate, 1,6-hexanediol diacrylate, 1,9-nonanediol diacrylate, 1,10-decanediol diacrylate, 1,12-dodecanediol diacrylate, diethylene glycol diacrylate, triethylene glycol diacrylate, tetraethylene glycol diacrylate, polyethylene glycol (200) diacrylate, polyethylene glycol (400) diacrylate, polyethylene glycol (600) diacrylate, dipropylene glycol diacrylate, tripropylene glycol diacrylate, ethoxylated bisphenol A diacrylate, alkoxylated hexanediol diacrylate, tricyclodecane dimethanol diacrylate, alkoxylated neopentyl glycol diacrylate, and caprolactone-modified hydroxypivalic ester neopentyl glycol diacrylate, trifunctional trimethylolpropane triacrylate, tris(2-hydroxyethyl) isocyanurate triacrylate, alkoxylated trimethylolpropane triacrylate, pentaerythritol triacrylate, and alkoxylated glyceryl triacrylate, tetra- or more-functional pentaerythritol tetraacrylate, ditrimethylolpropane tetraacrylate, dipentaerythritol pentaacrylate, and alkoxylated pentaerythritol tetracrylate, and other polyfunctional and hyperbranch type acrylates. Optionally, reactive monomers of various chemical structures maybe added. Further, for the purpose of improving adhesiveness and flexibility, reactive monomers may be additivewise employed optionally. These monomers may be used each alone or in combination of two or more. Particularly preferred are monofunctional or bifunctional acrylates on the ground that a cured film having a moderate hardness is obtained.

The monomer in question is usually employed as a diluent for viscosity adjustment, but since it reacts into a part of resin, it is also employable as a principal component in the case where the viscosity of the coating material exerts an influence on operability, for example, in case of adopting the ink jet printing method as the coating method.

As examples of the photopolymerization initiator, mention may be made of benzoin ether, thioxanthone, benzophenone, ketal, and acetophenone initiators. These may be used each alone or in combination of two or more. Above all, acetophenone initiators are preferred on the ground that a cured film scarcely undergoes yellowing.

As noted earlier, arbitrary components such as colorant, e.g., pigment or dye, dispersant, defoaming agent, crosslinking agent, polymerization initiator, heat stabilizer, light stabilizer, flame retardant, lubricant, and wettability improver, may be added to the coating material in question where required.

In connection with the coating material for ink jet printing, when the flexibility of a cured film, physical properties of the cured film such as follow-up performance and adhesiveness for the natural leather, and the viscosity and dischargeability as the coating material for ink jet printing, are taken into account synthetically, the content of the oligomer is preferably in the range of 10 to 40 wt %, more preferably 15 to 30 wt %, the content of the monomer is preferably in the range of 50 to 85 wt %, more preferably 55 to 75 wt %, and the content of the photopolymerization initiator is preferably in the range of 1 to 10 wt %, more preferably 3 to 7 wt %.

The viscosity at normal temperature of the coating material for ink jet printing is preferably in the range of 1 to 100 cps, more preferably 5 to 50 cps. If the viscosity is lower than 1 cps, there is a fear that it may be difficult to finely adjust the amount of the coating material to be discharged and dischargeability may become unstable, and thereby the coating material may be discharged in a larger amount than a preset amount or a discharged droplet may not arrive at a desired position. If the viscosity exceeds 100 cps, there is a fear that the discharge of the coating material from a nozzle may become difficult even if a lowering of viscosity is performed by heating. In the present invention, the viscosity was measured under the condition of 25° C. by using a Model B viscometer, VISCOMETER TV-20L (a product of Toki Sangyo Co., Ltd.).

The ink jet printer employable in the present invention is not specially limited. There may be used an ink jet printer fabricated by equipping a printer head in a conventional ink jet printer with a heater to reduce viscosity by heating. In this case, the heating temperature is preferably a temperature at which the texture of the natural leather does not become hard. For example, it is in the range from normal temperature to 150° C., more preferably 30 to 70° C.

After application of the coating material to the surface of the undercoating layer of the natural leather, ultraviolet light is irradiated to the coating material to cure the resin. Conditions for the irradiation of ultraviolet light involve, for example, a voltage of 80 to 200 W/cm and a time of 0.1 to 5 seconds.

In ink jet printing, the thickness of the resin portion and the amount of resin coating are in a substantially proportional relation on the assumption that other conditions, e.g., surface free energy of the undercoating layer, static surface tension and viscosity of the coating material for forming the resin portion, and print pattern, are the same. The amount of resin coating is determined by the product of the discharge quantity of the coating material for forming the resin portion and the number of times of repetition of the discharge. The discharge quantity can be adjusted by changing drive conditions for the printer head and the number of times of repletion can be adjusted by changing the resolution or by lap-printing. That is, by adjusting these conditions it is possible to form a resin portion having a desired thickness.

In the three-dimensionally patterned natural leather according to the present invention it is essential that the three-dimensional pattern be formed by resin coated partially in a pattern shape on the surface of the undercoating layer of the natural leather. Where required, an overcoating layer may be formed on the surface of the three-dimensional pattern. With the overcoating layer, it is possible to improve the abrasion resistance. The overcoating layer may comprise one or two or more coating layers.

The thickness of the overcoating layer is not specially limited, but is preferably in the range of 10 to 40 μm, more preferably 15 to 30 μm. If it is less than 10 μm, there is a fear that it may be difficult to form a uniform overcoating layer and the overcoating layer formed may be dropped out partially. If the thickness of the overcoating layer exceeds 40 μm, there is a fear that the texture and sense of touch of the entire leather may become hard and thereby the characteristics peculiar to the natural leather may be impaired or the three-dimensional pattern may disappear.

Resin used for forming the overcoating layer is almost the same as the resin used in the undercoating layer, provided that from the standpoint of abrasion resistance a smoothing agent and a crosslinking agent be added as additives to the overcoating layer serving as an outermost layer. Method for coating and subsequent heat treatment are the same as is the case with the undercoating layer.

The undercoating layer and the three-dimensional pattern (resin portion) may be of the same color or different colors. Further, the three-dimensional pattern may be formed with colorless, transparent resin and a design characteristic may be imparted to the leather by only shadowing of the three-dimensional pattern.

### EXAMPLES

The present invention will be described in more detail hereinafter by way of examples, but the invention is not limited by those examples. Evaluation tests in the examples were conducted in the following manner.

### (a) Three-Dimensional Feeling

Three-dimensionally patterned natural leathers obtained in Examples and Comparative Examples were observed visually and evaluated in accordance with the following criterion:
◯: has a clear three-dimensional feeling
Δ: has a three-dimensional feeling, which, however, is somewhat unclear.
x: does not have a three-dimensional feeling

### (b) Minuteness of Three-Dimensional Pattern

Out of the three-dimensionally patterned natural leathers obtained in Examples and Comparative Examples, with respect to those obtained in Examples 1-3, 6, 7 and Comparative Examples 1-3 each having a three-dimensional grain pattern (a pattern entirely comprising one pixel wide lines), the line thickness at an arbitrary place was measured and evaluated in accordance with the following criterion:
◯: 1 mm or less
Δ: 1-2 mm
x: 2 mm or more

### (c) Texture

The three-dimensionally patterned natural leathers obtained in Examples and Comparative Examples were touched and evaluated in accordance with the following criterion:
◯: soft and retains the sense of touch of a natural leather
Δ: somewhat deficient in softness
x: hard and does not retain the sense of touch of a natural leather

### (d) Abrasion Resistance

With respect to each of the three-dimensionally patterned natural leathers obtained in Examples and Comparative Examples, a test piece 70 mm wide by 300 mm long and a like test piece were sampled in longitudinal and transverse directions, respectively, and a urethane foam 70 mm wide by 300 mm long by 10 mm thick was applied to the back side of each test piece. Each test piece was rubbed with a rubbing piece covered with cotton cloth under a load of 9.8N. The rubbing piece was reciprocated 10000 times at a rate of 60 reciprocations per minute over a distance of 140 mm on the surface of the test piece. The test piece after the rubbing was observed visually and evaluated in accordance with the following criterion:
◯: There is little difference in three-dimensional feeling in comparison with the state before rubbing.
Δ: The three-dimensional feeling somewhat diminishes in comparison with that before rubbing.
x: The three-dimensional feeling almost disappeared.

### (e) Disappearance of Three-Dimensional Feeling

The three-dimensionally patterned natural leathers obtained in Examples and Comparative Examples were subjected to milling at 15 rpm for 30 minutes with use of OCTAGONAL MILLING DRUM (a product of BAGGIO TECNOLOGIEs. r. l.), then test pieces after the milling were observed visually and evaluated in accordance with the following criterion:
◯: no disappearance of the three-dimensional pattern in comparison with that before milling.
Δ: The three-dimensional pattern somewhat disappeared in comparison with that before milling.
x: The three-dimensional pattern almost disappeared in comparison with that before milling.

### Example 1

### (1) Production of Crust

An adult cow hide was used as a raw hide and was gone through the ordinary process, then was subjected to chromium tanning, squeezing, shaving, re-tanning, neutralizing, dyeing, oiling, samming, drying, conditioning, staking, toggling, trimming, and buffing. The dyeing was carried out so to give the same color as that of the undercoating layer.

### (2) Formation of Undercoating Layer

The materials described in Formulation 1 were mixed with a mixer to prepare a coating material for forming an undercoating layer. At this time, using a cup viscometer (a product of ANEST IWATA Corp.), viscosity was adjusted with a thickener and pure water so as to give a viscosity of 45 seconds.

### Formulation 1

| | |
|---|---|
| LCC FF Color YELLOW F3R | 10 wt parts |
| (pigment, a product of Dainippon Ink And Chemicals, | |
| Incorporated) | |
| LCC Filler MK-45 | 10 wt parts |
| (anti-tack agent, a product of Dainippon Ink And | |
| Chemicals, Incorporated) | |
| LCC BINDER SX-707 | 30 wt parts |
| (acryl emulsion, a product of Dainippon Ink And | |
| Chemicals, Incorporated) | |
| LCC BINDER UB-1100 | 30 wt parts |
| (urethane emulsion, a product of Dainippon Ink And | |
| Chemicals, Incorporated) | |
| LCC ASSISTER RL | 2 wt parts |
| (wettability improver, a product of Dainippon Ink | |
| And Chemicals, Incorporated) | |
| LCC Thickener NA-3 | proper quantity |
| (thickener, a product of Dainippon Ink And Chemicals, | |
| Incorporated) | |
| Pure water | proper quantity |

Using a reverse roll coater, the undercoating layer-forming coating materials was applied to the natural leather after grain stripping so as to give a total wet coating quantity of 80 g/m² and was then heat-treated for 5 minutes using a dryer held at 80° C. The resultant undercoating layer had a thickness of 25 μm and surface free energy at 25° C. of 36.8 dyne/cm.

### (3) Formation of Resin Portion

The materials of Formulation 2 were mixed with a mixer, then were dispersed for 3 hours with a beads mill, followed by filtration, to prepare a coating material for forming a resin portion. The coating material was found to have a static surface tension at 25° C. of 28.4 dyne/cm. The value obtained by subtracting the static surface tension at 25° C. of the resin portion-forming coating material from the surface free energy at 25° C. of the undercoating layer was 8.4 dyne/cm. The viscosity at 25° C. of the resin portion-forming coating material was 54.4 cps and that at 60° C. was 14.5 cps. Further, Martens hardness of a cured film formed separately was 6 N/mm².

### Formulation 2

| | |
|---|---|
| IRGALITE BLUE GLNF | 2 wt parts |
| (copper phthalocyanine pigment, a product of Ciba | |
| Specialty Chemicals Inc.) | |
| FLOWLEN DOPA-33 | 1 wt part |
| (dispersant, a modified acrylic copolymer, a product | |
| of Kyoeisha Chemical Co., Ltd.) | |
| CN981 | 25 wt parts |
| (aliphatic urethane acrylate oligomer, a product of | |
| Sartomer Company, Inc.) | |
| SR9003 | 31 wt parts |
| (propoxylated (2)neopentyl glycol diacrylate, a product | |
| of Sartomer Company, Inc.) | |
| SR489 | 31 wt parts |
| (tridecyl acrylate, a product of Sartomer Company, Inc.) | |
| DAROCURE 1173 | 10 wt parts |
| (photopolymerization initiator, 2-hydroxy-2-methyl-1- | |
| phenyl-propane-1-one, a product of Ciba Specialty | |
| Chemicals Inc.) | |

Using an ink jet printer, the resin portion-forming coating material was printed onto the surface of the undercoating layer of the natural leather and was then irradiated with ultraviolet light to cure the resin, thereby affording a three-dimensionally patterned natural leather according to the present invention. Printing conditions and ultraviolet light irradiating conditions are as follows. The resin portion thus formed was found to have a maximum thickness of 200 μm.

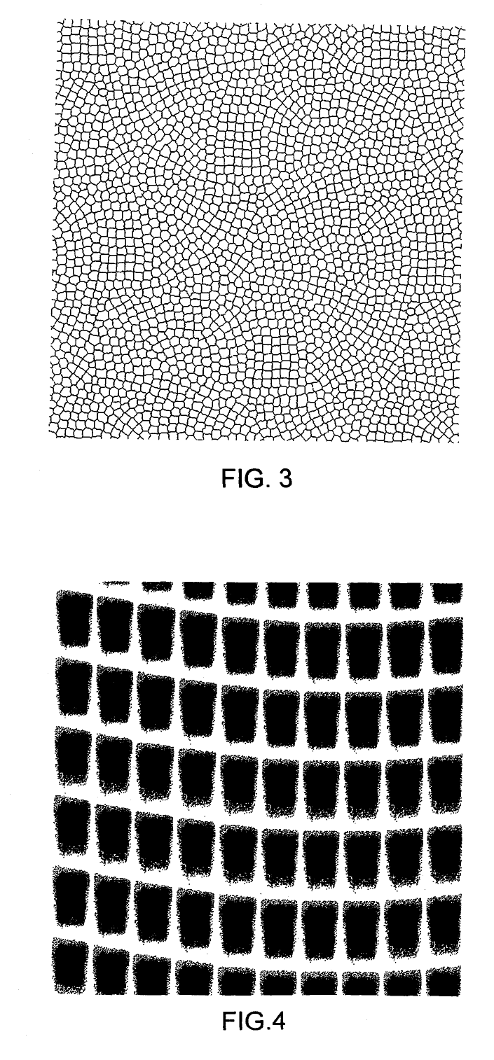

### Printing Conditions

| | |
|---|---|
| Heat heating temp.: | 60° C. |
| Nozzle dia.: | 70 μm |
| Applied voltage: | 50 V |
| Pulse width: | 20 μs |
| Drive frequency: | 1 kHz |
| Resolution: | 360 dpi |
| Print pattern: | grain pattern (FIG. 3, the coating |
| | ratio obtained from image data is |
| | 11%) |
| Amount of resin coating: | 200 g/m² (the amount of resin |
| | coating represents an average |
| | coating quantity of the resin- |
| | coated portion, with no |
| | consideration given to the resin- |
| | uncoated portion) |

### Ultraviolet Light Irradiating Conditions

| | |
|---|---|
| Lamp: | metal halide lamp |
| Voltage: | 120 W/cm |
| Irradiation time: | 1 second |
| Irradiation height: | 10 mm |

### Example 2

A three-dimensionally patterned natural leather according to the present invention was fabricated in the same way as in Example 1 except that a coating material of Formulation 3 was used as the resin portion-forming coating material and the amount of resin coating was changed to 20 g/m². The coating material was found to have a static surface tension at 25° C. of 32.2 dyne/cm. The value obtained by subtracting the static surface tension at 25° C. of the resin portion-forming coating material from the surface free energy at 25° C. of the undercoating layer was 4.6 dyne/cm. The viscosity at 25° C. of the coating material was 90.3 cps and that at 60° C. was 25 cps. Martens hardness of a cured film formed separately was 25 N/mm². The resin portion thus formed was found to have a maximum thickness of 20 μm.

### Formulation 3

| | |
|---|---|
| IRGALITE BLUE GLNF | 2 wt parts |
| (copper phthalocyanine pigment, a product of Ciba | |
| Specialty Chemicals Inc.) | |
| FLOWLEN DOPA-33 | 1 wt part |
| (dispersant, a modified acrylic copolymer, a product | |
| of Kyoeisha Chemical Co., Ltd.) | |
| CN981 | 25 wt parts |
| (aliphatic urethane acrylate oligomer, a product of | |
| Sartomer Company Inc.) | |
| SR9003 | 62 wt parts |
| (propoxylated (2)neopentyl glycol diacrylate, a product | |
| Of Satomer Company Inc.) | |
| DAROCURE 1173 | 10 wt parts |
| (photopolymerization initiator, 2-hydroxy-2-methyl-1- | |
| phenyl-propane-1-one, a product of Ciba Specialty | |
| Chemicals Inc.) | |

### Example 3

A three-dimensionally patterned natural leather according to the present invention was fabricated in the same way as in Example 1 except that the amount of resin coating was changed to 400 g/m². The resin portion thus formed was found to have a maximum thickness of 400 μm.

### Example 4

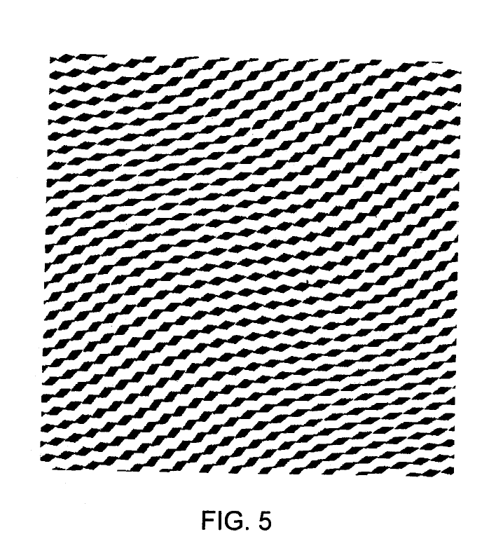

A three-dimensionally patterned natural leather according to the present invention was fabricated in the same way as in Example 1 except that the print pattern was changed to an alligator pattern (FIG. 4, the coating ratio obtained from image data was 67%) and that the amount of resin coating was changed to 50 g/m². The resin portion thus formed was found to have a maximum thickness of 100 μm.

### Example 5

A three-dimensionally patterned natural leather according to the present invention was fabricated in the same way as in Example 1 except that the print pattern was changed to a geometrical pattern (FIG. 5, the coating ratio obtained from image data was 32%). The resin portion thus formed was found to have a maximum thickness of 200 μm.

### Example 6

A three-dimensionally patterned natural leather according to the present invention was fabricated in the same way as in Example 1 except that a coating material of Formulation 4 was used as the resin portion-forming coating material. The coating material was found to have a static surface tension at 25° C. of 19.8 dyne/cm. The value obtained by subtracting the static surface tension at 25° C. of the resin portion-forming coating material from the surface free energy at 25° C. of the undercoating layer was 17.0 dyne/cm. The viscosity at 25° C. of the coating material was 52.5 cps and that at 60° C. was 14.2 cps. Martens hardness of a cured film formed separately was 6 N/mm². The resin portion thus formed was found to have a maximum thickness of 155 μm.

### Formulation 4

| | |
|---|---|
| IRGALITE BLUE GLNF | 2 wt parts |
| (copper phthalocyanine pigment, a product of Ciba | |
| Specialty Chemicals Inc.) | |
| FLOWLEN DOPA-33 | 1 wt part |
| (dispersant, a modified acrylic copolymer, a product | |
| of Kyoeisha Chemical Co., Ltd.) | |
| CN981 | 25 wt parts |
| (aliphatic urethane acrylate oligomer, a product of | |
| Sartomer Company, Inc.) | |
| SR9003 | 31 wt parts |
| (propoxylated (2)neopentyl glycol diacrylate, a product | |
| of Sartomer Company, Inc.) | |
| SR489 | 30 wt parts |
| (tridecyl acrylate, a product of Sartomer Company, Inc.) | |
| DOW CORNING 57 ADDITIVE | 1 wt part |
| (wettability improver, a silicone compound, a product | |
| of Dow Corning Toray Co., Ltd.) | |
| DAROCURE 1173 | 10 wt parts |
| (photopolymerization initiator, 2-hydroxy-2-methyl-1- | |
| phenyl-propane-1-one, a product of Ciba Specialty | |
| Chemicals Inc.) | |

### Example 7

A three-dimensionally patterned natural leather according to the present invention was fabricated in the same way as in Example 1 except that a coating material of Formulation 5 (viscosity: 45 seconds) was used as the undercoating layer-forming coating material. Surface free energy at 25° C. of the undercoating layer formed was 22.2 dyne/cm. The value obtained by subtracting the static surface tension at 25° C. of the resin portion-forming coating material from the surface free energy at 25° C. of the undercoating layer was −6.2 dyne/cm. The resin portion thus formed was found to have a maximum thickness of 213 um.

### Formulation 5

| | |
|---|---|
| LCC FF Color YELLOW F3R | 10 wt parts |
| (pigment, a product of Dainippon Ink And | |
| Chemicals, Incorporated) | |
| LCC Filler MK-45 | 10 wt parts |
| (anti-tack agent, a product of Dainippon Ink And | |
| Chemicals, Incorporated) | |
| LCC BINDER SX-707 | 30 wt parts |
| (acryl emulsion, a product of Dainippon Ink And | |
| Chemicals, Incorporated) | |
| LCC BINDER UB-1100 | 30 wt parts |
| (urethane emulsion, a product of Dainippon Ink And | |
| Chemicals, Incorporated) | |
| LCC ASSISTER RL | 2 wt parts |
| (wettability improver, a product of Dainippon Ink And | |
| Chemicals, Incorporated) | |
| DOW CORNING TORAY 19 ADDITIVE | 3 wt parts |
| (wettability improver, silicone compound, a product of | |
| Dow Corning Toray Co., Ltd.) | |
| LCC Thickener NA-3 | proper quantity |
| (thickener, a product of Dainippon Ink And Chemicals, | |
| Incorporated) | |
| Pure water | proper quantity |

### Comparative Example 1

A three-dimensionally patterned natural leather was fabricated in the same way as in Example 1 except that the amount of resin coating was changed to 10 g/m². The resin portion thus formed was found to have a maximum thickness of 10 μm.

### Comparative Example 2

A three-dimensionally patterned natural leather was fabricated in the same way as in Example 1 except that the amount of resin coating was changed to 500 g/m². The resin portion thus formed was found to have a maximum thickness of 500 μm.

### Comparative Example 3

A natural leather having an undercoating layer was subjected to embossing at 80° C. for 5 seconds with use of a hydric type embossing machine to afford a natural leather having a three-dimensional grain pattern (FIG. 3).

Table 1 shows the results of evaluation of the three-dimensionally patterned natural leathers obtained in the above Examples and Comparative Examples.

TABLE 1

| | | Example 1 | Example 2 | Example 3 | Example 4 | Example 5 | Example 6 |
|---|---|---|---|---|---|---|---|
| Under- | Coating Material | 1 | 1 | 1 | 1 | 1 | 1 |
| coating | Formulation | | | | | | |
| Layer | Surface Free | 36.8 | 36.8 | 36.8 | 36.8 | 36.8 | 36.8 |
| | Energy | | | | | | |
| | [dyne/cm] (a) | | | | | | |
| Resin | Coating Material | 2 | 3 | 2 | 2 | 2 | 4 |
| Portion | Formulation | | | | | | |
| | Static Surface | 28.4 | 32.2 | 28.4 | 28.4 | 28.4 | 19.8 |
| | Tension of Coating | | | | | | |
| | Material | | | | | | |
| | [dyne/cm] (b) | | | | | | |
| | (a) − (b) | 8.4 | 4.6 | 8.4 | 8.4 | 8.4 | 17.0 |
| | Martens Hardness | 6 | 25 | 6 | 6 | 6 | 6 |
| | [N/mm²] | | | | | | |
| | Print Pattern | Grain | Grain | Grain | Alligator | Geometrical | Grain |
| | | pattern | pattern | pattern | pattern | pattern | pattern |
| | Coating Ratio [%] | 11 | 11 | 11 | 67 | 32 | 11 |
| | Amount of Resin | 200 | 20 | 400 | 50 | 200 | 200 |
| | Coating [g/m²] | | | | | | |
| | Maximum | 200 | 20 | 400 | 100 | 200 | 155 |
| | Thickness [μm] | | | | | | |
| Evaluation | Three-dimensional | ∘ | ∘ | ∘ | ∘ | ∘ | Δ |
| Item | Feeling | | | | | | |
| | Minuteness of | ∘ | ∘ | ∘ | — | — | Δ |
| | Three-dimensional | | | | | | |
| | Pattern | | | | | | |
| | Texture | ∘ | Δ | ∘ | Δ | ∘ | ∘ |
| | Abrasion Resistance | ∘ | Δ | ∘ | ∘ | ∘ | ∘ |
| | Disappearance of | ∘ | ∘ | ∘ | ∘ | ∘ | ∘ |
| | Three-dimensional | | | | | | |
| | Pattern | | | | | | |
| | Overall | ∘ | Δ | ∘ | Δ | ∘ | Δ |
| | Evaluation | | | | | | |

| | | | Comparative | Comparative | Comparative |
|---|---|---|---|---|---|
| | | Example 7 | Example 1 | Example 2 | Example 3 |
| Under- | Coating Material | 5 | 1 | 1 | 1 |
| coating | Formulation | | | | |
| Layer | Surface Free | 22.2 | 36.8 | 36.8 | 36.8 |
| | Energy | | | | |
| | [dyne/cm] (a) | | | | |
| Resin | Coating Material | 2 | 2 | 2 | — |
| Portion | Formulation | | | | |
| | Static Surface | 28.4 | 28.4 | 28.4 | — |
| | Tension of Coating | | | | |
| | Material | | | | |
| | [dyne/cm] (b) | | | | |
| | (a) − (b) | −6.2 | 8.4 | 8.4 | — |
| | Martens Hardness | 6 | 6 | 6 | — |
| | [N/mm²] | | | | |
| | Print Pattern | Grain | Grain | Grain | (Grain |
| | | pattern | pattern | pattern | pattern) |
| | Coating Ratio [%] | 11 | 11 | 11 | — |
| | Amount of Resin | 200 | 10 | 500 | — |
| | Coating [g/m²] | | | | |
| | Maximum | 213 | 10 | 500 | — |
| | Thickness [μm] | | | | |
| Evaluation | Three-dimensional | ∘ | x | ∘ | ∘ |
| Item | Feeling | | | | |
| | Minuteness of | ∘ | ∘ | Δ | x |
| | Three-dimensional | | | | |
| | Pattern | | | | |
| | Texture | ∘ | ∘ | x | Δ |
| | Abrasion Resistance | Δ | Δ | ∘ | x |
| | Disappearance of | ∘ | ∘ | ∘ | x |
| | Three-dimensional | | | | |
| | Pattern | | | | |
| | Overall | Δ | x | x | x |
| | Evaluation | | | | |

1. A three-dimensionally patterned natural leather having an undercoating layer and a three-dimensional pattern formed on the surface of the undercoating layer, the three-dimensional pattern being formed by a resin portion which covers by coating the surface of the undercoating layer partially in a pattern shape, the resin portion having a maximum thickness of 20 to 400 μM.

2. A three-dimensionally patterned natural leather according to claim 1, wherein the ratio of coating of the resin portion for the surface of the undercoating layer is in the range of 3 to 60%.

3. A three-dimensionally patterned natural leather according claim 1, wherein the resin portion has a Martens hardness of 1 to 10 N/mm².

4. A three-dimensionally patterned natural leather according to claim 1, wherein the resin portion is formed by a cured product of an ultraviolet curable resin.

5. A method for fabricating a three-dimensionally patterned natural leather, comprising the steps of:
applying a coating material for forming an undercoating layer to the surface of a natural leather and applying a heat treatment to the coating material to form an undercoating layer; and
applying a coating material for forming a resin portion to the surface of the undercoating layer partially in a pattern shape and applying a heat treatment or ultraviolet light irradiation to the coating material to form a three-dimensional pattern comprising a resin portion, the resin portion having a maximum thickness of 20 to 400 μm.

6. A method according to claim 5, wherein the value obtained by subtracting a static surface tension at 25° C. of the resin portion-forming coating material from surface free energy at 25° C. of the undercoating layer is in the range of −5 to 15 dyne/cm.

7. A method according to claim 5, wherein the application of the resin portion-forming coating material is performed by ink jet printing.

8. A method according to claim 6, wherein the application of the resin portion-forming coating material is performed by ink jet printing.

9. A three-dimensionally patterned natural leather according to claim 2, wherein the resin portion has a Martens hardness of 1 to 10 N/mm².

10. A three-dimensionally patterned natural leather according to claim 2, wherein the resin portion is formed by a cured product of an ultraviolet curable resin.

11. A three-dimensionally patterned natural leather according to claim 3, wherein the resin portion is formed by a cured product of an ultraviolet curable resin.
